(19) United States
(12) Patent Application Publication
(10) Pub. No.: US 2022/0187617 A1
(43) Pub. Date: Jun. 16, 2022

(54) LENS DRIVING DEVICE, CAMERA DEVICE AND ELECTRONIC APPARATUS

(71) Applicant: New Shicoh Motor Co., LTD, Zhejiang (CN)

(72) Inventor: Noriyuki WASHIO, Yamato City (JP)

(21) Appl. No.: 17/536,657

(22) Filed: Nov. 29, 2021

(30) Foreign Application Priority Data
Dec. 11, 2020 (CN) 202011442340.1

(51) Int. Cl. G02B 27/64; G02B 7/02; G02B 7/09; H04N 5/225; G03B 17/14

(52) U.S. Cl. CPC G02B 27/646; G02B 7/023; G03B 17/14; H04N 5/2253; H04N 5/2254; G02B 7/09

(57) ABSTRACT

A lens driving device can movably support a lens body and arrange an image sensor on a rear side of the lens body. The lens driving device includes an opening provided between the lens body and the image sensor, the opening for passing light from the lens body to the image sensor and restricting light, wherein an inner edge forming the opening has an inclined portion such that a size of the opening becomes larger as it goes to the rear side, and the inclined portion has a serrated portion in which a plurality of ridges extend forward and backward along an inclination of the inclined portion.

### CROSS-REFERENCE TO RELATED APPLICATIONS

This application claims priority to Chinese Patent Application No. 202011442340.1 filed Dec. 11, 2020, which is hereby incorporated by reference herein in its entirety.

### TECHNICAL FIELD

The present disclosure relates to a lens driving device used in electronic apparatus such as smartphones, a camera device and an electronic apparatus.

### BACKGROUND

Some lens driving devices among the lens driving device that have both OIS (Optical Image Stabilizer) function and AF (Auto Focus) function are called periscopic type. In the periscopic type of lens driving device, a lens body and an image sensor are arranged side by side in a direction orthogonal to the incident direction of the light from a subject, the light from the subject is reflected by a prism or a mirror, the optical axis is bent and the light enters the lens body, and the light transmitted through the lens body is converted into an image signal by the image sensor. As a document disclosing a technique related to this type of lens driving device, Japanese Patent Application Laid-Open No. 2019-139223A (hereinafter referred to as Patent Document 1) can be given.

### SUMMARY

However, in the periscopic type of lens driving device, the light emitted from the lens body and incident on the image sensor includes not only the light that is directly incident on the image sensor, but also the light that is incident after being reflected by other objects. There were cases when a ghost image occurred. The present disclosure has been made in view of such a problem, and the present disclosure aims to provide a lens driving device in which a ghost image is unlikely to occur.

In order to solve the above-described mentioned problem, in accordance with a first aspect of the present disclosure, there is provided a lens driving device capable of movably supporting a lens body and arranging an image sensor on a rear side of the lens body, and including an opening provided between the lens body and the image sensor, the opening for passing light from the lens body to the image sensor and restricting light, wherein an inner edge forming the opening has an inclined portion such that a size of the opening becomes larger as it goes to the rear side, and the inclined portion has a serrated portion in which a plurality of ridges extend forward and backward along an inclination of the inclined portion.

In accordance with a second aspect of the present disclosure, there is provided a camera device including the lens driving device described above.

In accordance with a third aspect of the present disclosure, there is provided an electronic apparatus including the camera device described above.

Further features of the present invention will become apparent from the following description of exemplary embodiments (with reference to the attached drawings).

### BRIEF DESCRIPTION OF DRAWINGS

FIG. 1 is a front view of a smartphone on which a camera device including a lens driving device, according to one embodiment of the present disclosure, is mounted;

FIG. 2 is a perspective view of the lens driving device shown in FIG. 1;

FIG. 3 is a perspective view in which the case is removed from the lens driving device shown in FIG. 2; and

FIG. 4 is an enlarged partial sectional view around a holder opening and a case opening shown in FIG. 2.

### DETAILED DESCRIPTION

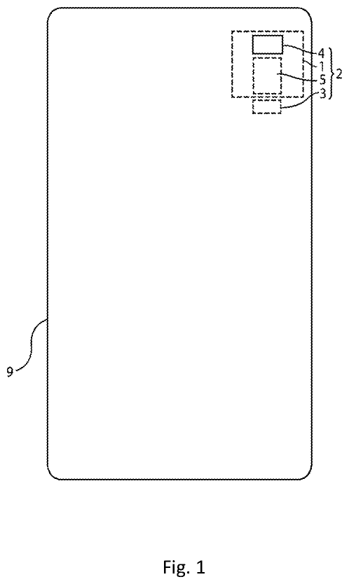

Hereinafter, embodiments of the present disclosure are explained with reference to drawings. As shown in FIG. 1, a camera device 2 including a lens driving device 1 according to one embodiment of the present disclosure is accommodated in a smartphone 9.

The camera device 2 has an image sensor 3, a mirror 4 that reflects light from a subject, a lens body 5 that guides the light reflected by the mirror 4 to the image sensor 3, and a lens driving device 1 that drives the lens body 5.

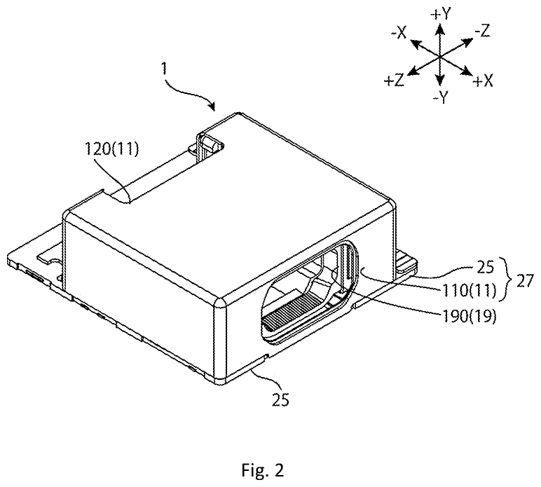

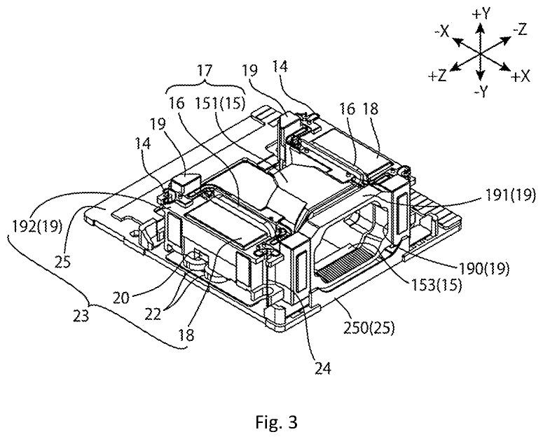

As shown in FIGS. 2 and 3, hereinafter, a direction of the center where the light from the subject is incident on the mirror 4 is appropriately referred to as a Y direction. Further, one direction in which the light reflected by the mirror 4 is directed toward the lens body 5 is referred to as an X direction, and a direction orthogonal to the Y direction and the X direction is referred to as a Z direction. Further, as indicated in FIGS. 2 to 4, the +Y side may be referred to as an upper side, the −Y side may be referred to as a lower side, the −X side may be referred to as a front side, the +X side may be referred to as a rear side, the +Z side may be referred to as a left side, and the −Z side may be referred to as a right side.

The lens body 5 has a lens incorporated in a lens barrel. The lens driving device 1 has a movable portion 17, an intermediate member 23 and a fixed portion 27. The lens body 5 is attached to a carrier 15 which belongs to the movable portion 17. The intermediate member 23 is supported by suspension wires 24 so as to be movable in the X direction and the Z direction together with the movable portion 17 with respect to the fixed portion 27. The movable portion 17 is supported by leaf springs 14 so as to be movable in the Y direction with respect to the intermediate member 23.

The movable portion 17 is configured to have a carrier 15 to which first coils for OIS (Optical Image Stabilizer) 16 are attached. One end of the leaf spring 14 is attached to the carrier 15. The intermediate member 23 is configured to have a holder 19 to which magnets for OIS 18 and magnets for AF (Auto Focus) 20 are attached. The other end of the leaf spring 14 is attached to the holder 19. Further, one end of the suspension wire 24 is fixed to an extension portion extending beyond the other end of the leaf spring 14. The fixed portion 27 has a case 11 and a base 25. Coils for AF 22 are attached to the base 25, and a second coil for OIS (not shown) is attached to this fixed portion 27. The other end of the suspension wire 24 is fixed to the base 25.

The case 11 and the base 25 are combined as a housing. The case 11 has a box shape, and a case opening 110 is provided in the center of the rear side wall of the case 11. The center of the front side wall of the case 11 is provided with a notch 120 cut out from the lower end to the upper end, and a portion of the upper wall is also cut out by the notch 120. The image sensor 3 is provided on the rear side of the case opening 110. A second coil for OIS (not shown) is arranged on the inner side of the upper wall of the case 11.

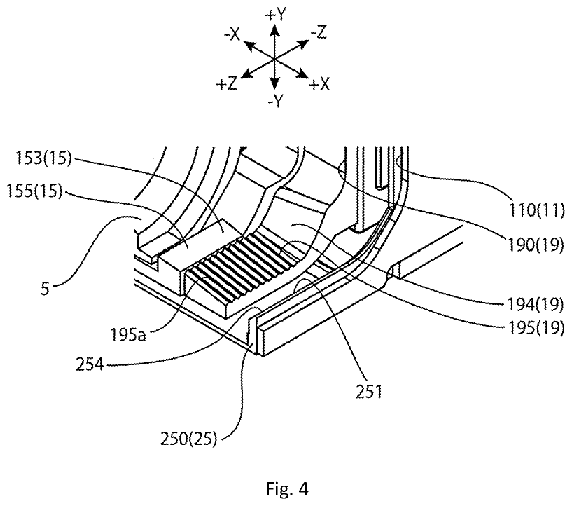

The base 25 is shaped like a quadrangular plate, the edge on the rear side of the base 25 is provided with a rising portion 250 rising up to the upper side, and the upper surface of the portion on the front side is provided with a mirror attachment portion. As shown in FIG. 4, the rising portion 250 constitutes a portion of a base opening 251. Further, an electric wiring is formed on the base 25. As shown in FIG. 3, the coils for AF 22 are provided on the upper surface of the base 25 on the left side and the right side.

As shown in FIG. 3, the holder 19 has a frame portion 191 surrounding a holder opening 190 through which light emitted from the lens body 5 passes, and a side wall portion 192 extending forward from the left and right peripheral edge portions of the frame portion 191. The holder 19 is positioned on the upper side of the base 25 and is formed to surround the carrier 15 as a whole. Magnets for OIS 18 are provided on the left and right upper surfaces of the side wall portion 192. Magnets for AF 20 are provided on the left and right lower surfaces of the side wall portion 192 so as to oppose to the coils for AF 22.

The carrier 15 has a cylindrical body 151, whose top and bottom are collapsed. Further, the upper portion and the lower portion of the cylindrical body 151 on the front side are cut off to form side surface portions. A carrier opening 153 is formed at the rear end of the cylindrical body 151. The lens body 5 is fitted into the cylindrical body 151 from the front side of the carrier 15 and supported by the cylindrical body 151. The first coils for OIS 16 are provided on the outer surfaces of the left and right side surface portions of the carrier 15 so as to face the magnets for OIS 18.

The suspension wires 24 are metallic wires extending in the Y direction and are provided outside each of the four corner portions of the holder 19. The suspension wires 24 support the intermediate member 23 so that the intermediate member 23 can move in the X direction and the Z direction together with the movable portion 17 while floating from the base 25.

The leaf spring 14 is comprised of an arm bent in the XZ direction and extending in a thin wire shape. The above-described leaf spring 14 from one end to the other end is formed of one arm, the extension portion of the arm is formed in a ring shape, and one end of the suspension wire 24 is fixed at the center of the extension portion.

Next, the opening between the lens body 5 and the image sensor 3 is explained. As shown in FIG. 4, on the rear side of the lens body 5, a carrier opening 153, a holder opening 190, a base opening 251, and a case opening 110 are provided in order from the front side. An image sensor 3 (not shown in FIG. 4) is provided on this rear side. It is to be noted that in the present embodiment, the lower side portion of the opening is described, but the same structure is also provided for the upper side portion. In addition, the same structure is not provided for the left portion and the right portion, but the same structure may be provided.

The carrier opening 153 of the carrier 15 is provided immediately after the lens body 5. An inner edge forming the carrier opening 153 is provided with an inclined surface 155 such that the size of the opening becomes larger as it goes to the rear side.

The holder opening 190 of the holder 19 is located on the rear side of the carrier opening 153, and an inner edge forming the holder opening 190 is provided with an inclined portion 194 such that the size of the opening becomes larger as it goes to the rear side. The holder opening 190 is formed to be narrow in the up-down direction and wide in the left-right direction. The front end of the inclined portion 194 is located above the rear end of the inclined surface 155. The inclination of the inclined portion 194 is larger than the inclination of the inclined surface 155. The inclined portion 194 is provided with a serrated portion 195 in which a plurality of ridges 195a extend forward and backward along the inclination of the inclined portion 194. The ridges 195a of the serrated portion 195 extend in the X direction when viewed from the Y direction, and adjacent ridges 195a are parallel to each other. The angle of the top portion of the ridge 195a of the serrated portion 195 when cut in the YZ plane is preferably an angle other than 90 degrees, that is, an acute angle or an obtuse angle, and is formed at an obtuse angle in the present embodiment.

The rising portion 250 of the base 25 constituting a portion of the base opening 251 is provided on the rear side slightly separated from the holder opening 190. The upper end of the rising portion 250 is provided with an inverse inclined surface 254. The inverse inclined surface 254 as a whole is located slightly lower than the inclined portion 194 and faces the front upper side, that is, 45 degrees in the present embodiment.

The case 11 is provided so as to be almost in contact with the rear side of the rising portion 250, and the case opening 110 is provided immediately after the base opening 251. The upper end of the case opening 110 is located below the upper end of the rising portion 250.

The light emitted from the lens body 5 and becoming a ghost image is first removed by the carrier opening 153. Next, the light incident on the inclined portion 194 of the holder opening 190 through the carrier opening 153 is attenuated when reflected. Further, since the inclined portion 194 becomes the serrated portion 195 and the incident light is reflected in a direction different from the incident direction, a ghost image is unlikely to occur. At this time, when the angle of the top portion of the ridge 195a of the serrated portion 195 is 90 degrees, it becomes the same direction as the initial incident light when it is reflected twice, and the effect that the reflected light is directed in a different direction from the incident light is reduced. But since it is reflected twice, the attenuation effect caused by the reflection still exists. In cases where the angle of the top portion of the ridge 195a is an obtuse angle or an acute angle, even if it is reflected twice, it will not be reflected in the same direction as the incident light, so the effect that a ghost image is unlikely to occur is further improved.

Next, the light incident on the inverse inclined surface 254 of the base opening 251 through the holder opening 190 is not reflected toward the rear side, that is, the image sensor 3 side, but is reflected toward the front side, that is, the lens body 5 side, or the subject side. The upper end of the case opening 110 is located below the upper end of the rising portion 250 and has no significant effect on ghost image removal in the present embodiment.

Thus, the amount of light that forms a ghost image among the light emitted from the lens body 5 and incident on the image sensor 3 is reduced by the opening in the middle. That is, the light that forms a ghost image is reflected at the serrated portion 195, which makes it difficult for the light to be incident on the image sensor 3, and even if it is incident, the amount of light is attenuated. Further, it is reflected to the front side by the inverse inclined surface 254 and it is more difficult to be incident on the image sensor 3. Thereby, it is possible to provide a lens driving device in which a ghost image is unlikely to occur.

The first coil for OIS 16 provided on the movable portion 17 and the magnet for OIS 18 provided on the intermediate member 23 are opposed to each other. When an electric current flows in the first coil for OIS 16, an electromagnetic force in the Y direction is generated in the first coil for OIS 16. Thereby, the movable portion 17 moves in the Y direction with respect to the intermediate member 23.

The magnet for OIS 18 provided on the intermediate member 23 and the second coil for OIS (not shown) provided on the fixed portion 27 are opposed to each other. When an electric current flows in the second coil for OIS, an electromagnetic force in the Z direction is generated in the second coil for OIS. By this reaction, the intermediate member 23 moves in the Z direction with respect to the fixed portion 27 together with the movable portion 17.

The magnet for AF 20 provided on the intermediate member 23 and the coil for AF 22 provided on the fixed portion 27 are opposed to each other. When an electric current flows in the coil for AF 22, a thrust force in the X direction is generated in the coil for AF 22. By this reaction, the intermediate member 23 moves in the X direction with respect to the fixed portion 27 together with the movable portion 17.

It is to be noted that the lens driving device 1 according to the present embodiment has been described with respect to the periscopic lens driving device 1, but it is also applicable to a lens driving device 1 in which the optical axis is not bent. In addition, the lens body 5 may not include a lens barrel. In that case, the lens is directly attached to the carrier 15. In addition, the movable portion 17 does not need to move in three directions, and may move in two directions or move in one direction. In that case, it is also possible to perform an operation in place of the mirror 4 or the prism. In addition, the ridges 195a of the serrated portion 195 need not be parallel to each other and may have a shape that widens or narrows each other from the front side toward the rear side. In addition, the serrated portion 195 and the inverse inclined surface 254 may be provided on the same member. In addition, the serrated portion 195 may be provided on a member other than the holder 19, and the inverse inclined surface 254 may be provided on a member other than the base 25.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A lens driving device capable of movably supporting a lens body and arranging an image sensor on a rear side of the lens body, the lens driving device comprising:
an opening provided between the lens body and the image sensor, the opening for passing light from the lens body to the image sensor and restricting light, wherein
an inner edge forming the opening has an inclined portion such that a size of the opening becomes larger as it goes to the rear side, and
the inclined portion has a serrated portion in which a plurality of ridges extend forward and backward along an inclination of the inclined portion.

2. The lens driving device according to claim 1, wherein the adjacent ridges are parallel to each other.

3. The lens driving device according to claim 1, wherein an angle of a top of the ridge is an acute angle or an obtuse angle.

4. The lens driving device according to claim 1, wherein the opening is formed to be narrow in an up-down direction and wide in a left-right direction and the serrated portion is provided on at least one of an upper side or a lower side of the inner edge.

5. The lens driving device according to claim 1, further comprising a second opening on a rear side of the opening, wherein an inner edge forming the second opening comprises an inverse inclined surface such that a size of the second opening becomes smaller as it goes to the rear side.

6. The lens driving device according to claim 1, further comprising a movable portion, an intermediate member and a fixed portion, wherein:
the movable portion comprises a carrier on which the lens body can be attached, and is supported by the intermediate member so as to be movable with respect to the intermediate member,
the intermediate member is supported by the fixed portion so as to be movable together with the movable portion with respect to the fixed portion, and
the opening is formed in the intermediate member.

7. The lens driving device according to claim 5, further comprising a movable portion, an intermediate member and a fixed portion, wherein:
the movable portion comprises a carrier on which the lens body can be attached, and is supported by the intermediate member so as to be movable with respect to the intermediate member,
the intermediate member is supported by the fixed portion so as to be movable together with the movable portion with respect to the fixed portion, and
the second opening is formed in the fixed portion.

8. A camera device comprising the lens driving device of claim 1.

9. An electronic apparatus comprising the camera device of claim 8.
